(19) United States
(12) Patent Application Publication
(10) Pub. No.: US 2003/0009418 A1
(43) Pub. Date: Jan. 9, 2003

(54) Systems and methods for electronically verifying and processing information

(76) Inventors: Gerald M. Green, River Edge, NJ (US); Jiries M. Naber, W. Haverstraw, NY (US)

Correspondence Address: Kevin P. Crosby, Brinkley, McNerney, Morgan Solomon & Tatum, LLP, New River Center, 19th Floor, 200 East Las Olas Blvd., Fort Lauderdale, FL, 33301, US

(21) Appl. No.: 10/005,440

(22) Filed: Dec. 5, 2001

Related U.S. Application Data
(60) Provisional application No. 60/254,202, filed on Dec. 8, 2000.

(51) Int. Cl. G06F 17/60

(52) U.S. Cl. 705/38; 705/37

(57) ABSTRACT

A computer implemented method and system which provides current, reliable and accurate personal information regarding a prospective borrower and/or co-borrower. The system includes a central server which receives requests for personal information relating to proposed borrowers, which in turn parses out similar requests relating to that borrower to information sources such as, among others, the Internal Revenue Service, the Social Security Administration, the Daily Banking System and the pertinent credit bureaus. Information corresponding to the respective requests is retrieved from the information sources, and then compiled into a report format and forwarded to the requested party. The requested party may be the borrower/consumer individually, or may be a mortgage broker/agent, lending institution or other party authorized to request and obtain the information. An electronic signature or signatures accompany the request to the central server, which uses same to retrieve personal information data pertaining to the signatory(ies). Various encryption schemes may be employed for security purposes. The invention permits for the retrieval, compilation and reporting of relevant, personal data to a party or parties involved in the loan decision making process without any opportunity for the information to be tampered with by the proposed borrower(s) because the information is obtained electronically and directly from the information depositories.

### CLAIM OF PRIORITY

The present application is based on, and a claim to priority is made under 35 U.S.C. 119(e) to, provisional patent application currently pending in the U.S. Patent and Trademark Office having Serial No. 60/254,202 and Filing Date of Dec. 8, 2000.

### BACKGROUND OF THE INVENTION

1. Field of the Invention

The present invention concerns methods and apparatuses used to facilitate the collection of data such as that which is used to assess the credit risk of an applicant for a mortgage loan or other loan undertaking. The present invention concerns automated collection and compilation of information in a way which increases the reliability and the time freshness of the information.

2. Description of the Prior Art

Prior to extending a mortgage loan to a borrower, the lender makes a risk assessment relative to the applicant. This is done by gathering information from a multiplicity of sources. Presently, the gathering process is a manual one. As a result, it is relatively time consuming and labor intensive, and is fraught with the potential for inaccuracy, mistake and outright deception. Providers of mortgages desire to decrease the amount time and effort, and hence cost, required to evaluate the credit worthiness of potential borrowers.

The same holds true in the context of consumer applications for consumer credit. Typically, an applicant for consumer credit is not willing to wait for a prolonged period of time while information is manually gathered from a variety of independent sources. As a result, a significant amount of business opportunities are lost. Time is always of the essence in consumer lending since a consumer may change his or her purchase decision if the loan approval process is drawn out. Merchandisers, therefore, demand rapid loan approval, and lenders have to balance the desirability of rapid loan approval with the need to appropriately scrutinize a borrower's credit worthiness. However, more thorough checking of a person's credit, banking and employment history utilizing prior art systems requires the borrower to provide information on printed forms supplemented with additional information in the form of paper documentation such as income tax returns, paycheck stubs, W-2s, 1099s, bank account statements, etc. in order to facilitate a determination of the borrower's income and account balance, and to verify employment. The presentation of such documentation by the borrower allows fraudulent or misrepresented information to be provided by the borrower during the approval process. Therefore, a solution is called for through which credit, banking, employment background and other pertinent information can be gathered simultaneously and electronically in an expedited and efficient manner without the intervention of humans.

### SUMMARY OF THE INVENTION

It is an object of the present invention to provide a method and system which allows for the practically instantaneous and automated retrieval of data relevant to the decision to loan money or extend credit and compilation of that data into an easily used report format.

It is a further object of the present invention to provide lenders with a more accurate and recent evaluation of relevant information pertaining to the decision to lend money.

It is yet another object of the present invention to allow the novel retrieval of different types of information in an automated fashion to decrease the risk to providers of consumer loans.

The present invention satisfies these and further objectives by providing a computer implemented method and system which retrieves, among other things, credit, banking and employment-related information directly from the sources of that information, and then compiles the information automatically into a report which is transmitted to an inquiring party such as a lender to facilitate a convenient, efficient and expeditious credit-risk evaluation. The automated collection of this information results in more current, and therefore more accurate, information from a variety of sources to thereby provide a more accurate basis form which to evaluate credit worthiness.

In the preferred embodiment, the method permits a lending institution to directly interface with a central server over the Internet as a tunnel through which the lender requests information such as income verification, verification of employment (VOE) and verification of bank deposit (VOD), with maximum security measures such as electronic signatures meeting UETA compliance standards to identify the borrower. The central server will directly access information, electronically, from the Internal Revenue Service (IRS), the Social Security Administration (SSA), and the daily banking system (DBS), preferably by means such as a wide-area network (WAN), metropolitan area network (MAN) or a gateway in order to retrieve the information necessary to process a loan. The method and system will electronically replace the use of IRS Form 4506, and reliances on written and/or verbal VOD and VOE representations.

Direct electronic connection between the central server and the information sources referenced above through authorized and secure electronic means will drastically reduce fraud, predatory lending and paper within the mortgage industry, and will allow loans to be processed in a much shorter period of time than is currently experienced.

These and other objects and features of the invention will be more readily understood from a consideration of the following detailed description, taken with the accompanying drawings, in which corresponding parts are indicated by corresponding numerals.

### BRIEF DESCRIPTION OF THE DRAWINGS

FIG. 1 is a schematic representation of the system of the preferred embodiment of the invention;

FIG. 2 is a processing flow chart for implementation of the invention;

FIG. 3 is a schematic representation of an alternative form of the invention.

### DESCRIPTION OF PREFERRED AND ALTERNATIVE EMBODIMENTS

The present invention may be used in any application where a mortgage lender or credit provider desires to obtain data used in a decision to lend money and/or extend credit. The preferred embodiment used to illustrate the present invention is based upon a home mortgage approval process, although the invention is not intended to be limited to the home mortgages but can be used in connection, for example but not by way of limitation, commercial mortgages and consumer and commercial credit. Providers of home mortgages benefit from the improved accuracy of information provided by the present invention, which decreases the ability of a mortgage applicant to falsely represent data concerning his or her financial status. The reduction in processing time and labor due to the automated completion of loan application forms and the electronic forwarding of those forms is a further benefit to the lender.

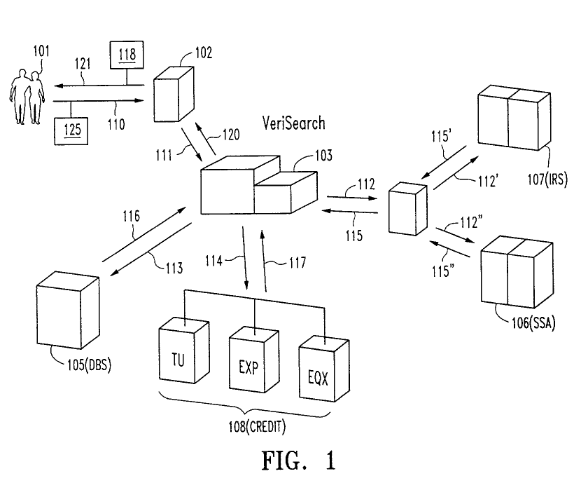

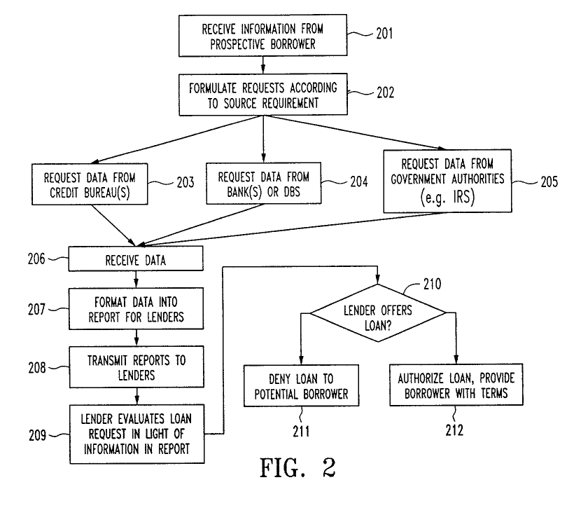

A schematic of the elements associated with the present invention is illustrated in FIG. 1 and the processing flow of the invention generally is shown in FIG. 2. FIG. 1 illustrates a borrower 101 who may be an individual or business entity desiring to obtain a mortgage loan or credit. The borrower 101 in the preferred embodiment may visit one of a plurality of agents 102. The agent 102 of the preferred embodiment may a licensed lending institution such as a mortgage broker. In the preferred embodiment of a licensed lender operation, the potential mortgagor is the borrower or loan applicant 101. The borrower 101 interacts with the agent 102 over one or more of any suitable communications media, such as in person, via voice communications over the telephone, via the completion of an application form on paper, which is completed in person or mailed to the agent 102, or by completion of a form on a computer terminal connected to the Internet or other computer network. In the course of interacting with the borrower 101, the agent 102 obtains identification information 110 from the borrower 101 in step 201. The preferred embodiment of the present invention may require verification of the identity of the borrower 101 in part by obtaining a signature, an electronic signature or biometric data from the borrower 101. Electronic signatures or biometric data are collected in the preferred embodiment by an applicant interface device 125. The applicant interface device 125 may be an electronic handwriting acceptor or a biometric measurement device such as a finger print reader, voice recognition device, retinal scanner or other device used to collect individual data used to identify a person, as are known to those skilled in the relevant arts.

The identification information 110 obtained by the agent 102 from the borrower 101 includes information that the financial information sources 105, 106, 107 and 108 require to identify their records that are associated with the borrower 101. This identification information 110 is dependent upon the requirements of the financial information sources, which are further defined below.

Once a completed set of information is obtained by the agent 102 in the preferred embodiment, that information is then reformatted for communication to a central server 103 via a formatted electronic message 111. The electronic message 111 may be communicated via a variety of channels, including the Internet, e-mail, modem, microwave signal, dial-up electronic connections, satellite communications links or other electronic communications channels. In alternative embodiments of the present invention, a printed document containing the collected information may be printed out as a paper record. The printed document may be formatted so as to facilitate recognition of the printed information by an electronic reader connected to the central server 103. Such a printed document may be communicated to the central server 103 by mail, courier, facsimile or other transmission methods. The central server 103 of the preferred embodiment parses the information received in the formatted electronic message 111 from the mortgage broker agent 102, and then formats other electronic messages 112, 113, 114 according to the requirements of the different information sources 105, 106,107 and 108 in step 202. The central server 103 then transmits the properly formatted other messages 112, 113 and 114 to the associated information sources in steps 203, 204 and 205.

The financial information sources utilized in the preferred embodiment include conventional credit reporting bureaus, the DBS and the IRS. In the preferred embodiment of the present invention, the central server 103 automatically requests and retrieves information via electronic communications from the IRS (for tax-related information), the SSA (for employment-related information) and the DBS (for banking information). In addition, information may be retrieved from other governmental entities, such as a state income tax or property taxing agency, all represented in step 205. Since mortgage lenders typically use the employee's W-2 and lines 7 and 31 of Form 1040 for taxpayers who file single or jointly, lines 1, 7, 31 and Schedules C & E of the tax returns of self-employed individuals, and the Form1099 and lines 1, 7, 31 of Schedule C of the tax return of independent contractors. Therefore, it is desirable that the IRS information obtained to prepare the report in conjunction with the instant invention include at least this information. Further, since the information obtained from the Social Security Administration includes the dates of employment, year-to-date gross earnings, and the amount of social security paid year-to-date for individuals, it is desirable to utilize at least that information for the report created in connection with the instant invention as well. Still further, since the information obtained from the Daily Banking System includes the last three month's ending monthly balances, the last three months of deposits by date for the account holder, and the last large withdrawal (used as an indication of down payment information) are utilized in the typical mortgage lending evaluation, it is desirable to have at least that information obtained automatically from the daily banking system to prepare reports in connection with this invention.

The preferred embodiment of the present invention obtains information from the U.S. Internal Revenue Service and the Social Security Administration. Due to security concerns regarding the data stored on the government computers, the preferred embodiment utilizes an intermediate computer or computers referred to herein as InfoServers 128, to act as communication buffers preventing the outside world from obtaining direct access to those computers,. The preferred embodiment does not utilize a direct communication between the government computers 106 and 107 and central server 103, thereby increasing the protection of the data stored on those government computers. The InfoServer 128 receives a batch transfer of data from the government computers 106 and 107 via a dedicated communications links 115′ and 115″, such as a T1 or T3 line, and not via a shared link such as the Internet. The InfoServer 128 may also communicate to the central server 103 over dedicated communication links 112 and 115 to enhance security. All communications from external systems, namely the central server 103, are handled by the InfoServer 128, which acts as a firewall and communications protection device in general to prevent and prohibit access to the actual IRS and SSA computer networks. The government computers may also include computers at other locations that are operated by State government agencies, such as state taxing agencies. Alternatively, all or any combination of government and/or private agencies whose information is used to prepare reports may share an InfoServer or InfoServers, or may interface with central server 103 via their own Info Server or Info Servers.

The IRS computer 107 provides information reported by the borrower 101 in conjunction with income tax filings. The information which the IRS computer may provide includes information contained on Internal Revenue Service Forms 1040, all Schedules associated with Form 1040, Forms 1099, Forms W2, Forms K1 and other forms associated with the borrower 101 or the business entity seeking a loan or credit. This information will be used to determine the income history of the borrower or business entity 101 seeking a loan or credit. In order for the IRS to provide this information, the preferred embodiment of the present invention provides a formatted electronic message 112′ to the IRS computer 107 through InfoServer 128 which contains the social security number, or the taxpayer identification number, of the borrower 101 as appropriate. Information on file pertaining to the borrower is then retrieved and communicated electronically to the InfoServer 128 via link 115′ and on to the central server 103 via link 115. The communications between the InfoServer 128 and the central server 103 in the preferred embodiment are achieved through a dedicated communications link, but the communications may be accomplished over any suitable electronic communications means, such as an Internet connection, modem connection or otherwise.

The preferred embodiment further requests information from the Social Security Administration. A computer or computers 106 associated with the Social Security Administration may provide information describing the employment and compensation history of the borrower 101, unemployment compensation which has been received from a State, and other income information. Data from the Social Security Administration in the preferred embodiment is sent via link 115″ to InfoServer 128 as which communicates via link 115 with central server 103. A formatted electronic message 112″ is sent to the InfoServer 128 which contains the borrower's social security or taxpayer identification number. Data on file within InfoServer 128 is then transmitted to central server 103 as discussed previously, whereupon it is incorporated with other data pertaining to the borrower and organized into a report.

The preferred embodiment further requests information concerning the borrower's bank account. The preferred embodiment may request information concerning the borrower's average bank account balance over a specified time period (such as the last 3 months), the deposit history of the borrower over a specified time period, and/or the current balance in the account associated with the borrower. This allows the loan decision to be based upon verified current and historic balance information that is provided contemporaneously by the bank and therefore more likely to be a valid representation of the borrower's banking information. To retrieve this information, the preferred embodiment provides a formatted message 113 to the bank (which may be the Daily Banking System), which causes a DBS computer to locate data files associated with the bank account number(s) provided by the borrower 101, as reflected in step 204. The formatted message 113 to the bank includes the credit applicant's bank account number(s) and potentially other identifying information. The bank account number and bank identification, such as bank name and address or an American Banking Association (ABA) identification, are obtained by the mortgage broker agent 102 from the borrower 101 in the identifying information 110. The information requested by server 103 is sent as a message 116 from the bank computer 105 for inclusion in a report by agent 102.

The financial information sources provide financial information concerning the borrower 101 and in the preferred embodiment also provide a confirmation code to identify that information. The confirmation code may be used by recipients of the information to later verify the information with the financial information source or to obtain updated information at a later time.

Once the central server 103 obtains the financial information messages 115, 116 and 117 in step 206 from the credit bureaus, the credit applicant's bank and government entities such as the Internal Revenue Service and Social Security Administration, a consolidated report 118 containing this enhanced information is automatically generated in step 207.

The consolidated report 118 is then sent to one or more lenders or credit providers (not shown) and/or to agent 102 in step 208. Example lenders and/or credit providers used by the preferred embodiment of an automated mortgage system are banks, mortgage brokers and other financing sources known to finance providers. The format of this consolidated report 118 may be tailored to each lender or credit provider. This consolidated report 118 may be formatted to facilitate reading by a human, such as in PDF format, or the report may be formatted for automated interpretation by software resident in the computers operated by the lenders or by an electronic reading machine or scanner. In addition to the consolidated report 118, the central server 103 of the preferred embodiment may also transmit a confirmation code. The confirmation code is provided by the financial information source and may be used by the lender to verify or reconfirm the information received.

Once the lenders and/or credit providers receive the consolidated report 118 with information pertaining to the credit worthiness of the borrower 101, the lenders and/or credit providers then determine if the credit applicant meets the requirements of that lender or credit provider. Lenders and credit providers may use the additional information provided by the present invention, e.g. more accurate and contemporaneous bank account balances and verified information obtained directly from government entities, such as taxing authorities, to better assess the credit risk presented by the borrower than can be achieved with the presently employed practices.

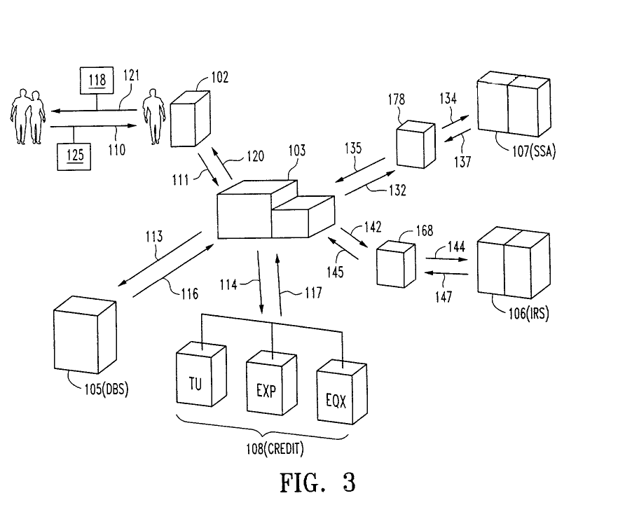

As an alternative to the configuration shown in FIG. 1, the government computers 106 and 107 may connect to central server 103 via proprietary infoservers 168 and 178, respectively, as shown in FIG. 3. And, as is the case with the InfoServer 128 shown in FIG. 1, the information accessed by central server 103 may be exported to the respective InfoServer from the corresponding government computer, ahead of time, such as by batch transfer of information at specified time intervals or as information content reaches predetermined levels, so that such information resides on the InfoServers 128, 168 and 178. It is preferred, although not required, that the information exported to the InfoServer with the information imported to InfoServers 128, 168 and 178 is limited to the particular information required for the lending analysis, such as W2 information, information from lines 7 and 31 of Form 1040, etc. as described above. However, the extent or level of information residing on InfoServers 128, 168 and 178 need only the dictated by the specific information needed to perform a lending evaluation. Any information beyond that may or may not be provided to InfoServers 128, 168 and/or 178, depending upon decisions made by the respective governmental agencies and the proprietors of the InfoServer(s) and/or central server 103.

It is also to be appreciated that an InfoServer or InfoServers (not shown) may be associated with communication links 113, 114, 116 and 117 so as to act as a buffer between central server 103 and the respective banks, Daily Banking System, and/or credit bureaus.

The financial information communicated and stored in the above described systems is very sensitive, and security against unauthorized access is therefore a concern. The preferred embodiment of the present invention utilizes several layers of electronic security as are known to practitioners in the relevant arts. The borrower 101 may be required to identify himself or herself by an electronic signature, which may be, for example but not by way of limitation, an electronically interpreted hand written signature or an electronic signature obtained from an encryption device carried by the borrower 101. The preferred embodiment further utilizes electronic verification, through encrypted verification fields as are known to practitioners of the relevant arts, of electronic messages communicated among the various computers involved in each transaction.

The preferred embodiment illustrates a home mortgage application scenario. It is obvious that the present invention may also be applied to consumer borrowing in retail stores, in association with an automobile purchase, in obtaining a cash loan from a bank or other lender, or in other environments. The enhanced information provided by the present invention will improve the ability of all consumer credit providers to better assess the credit worthiness of credit applicants in a rapid, almost instantaneous manner to reduce the credit provider's losses due to loan defaults. It is also obvious that further benefits of the present invention include a reduction in the cost of manual labor required to process loan applications, a reduction in foreclosures or repossessions for the loan or mortgage underwriters, a reduction in fraud, and a reduction in the costs of long distance facsimile transmissions. Moreover, the automated collection of data from third parties, such as the Social Security Administration, the Internal Revenue Service and the Daily Banking System, greatly reduces the ability of a mortgage loan or other credit applicant to falsify his or her personal information through presentation of false employment, tax or bank statements.

The data communications elements of the present invention may also be used to verify that there are sufficient funds in the associated bank account to cover a check presented by the borrower 101. Such a check may be for the down payment presented at a real estate closing in the case of a real estate mortgage, or of a check or debit card charge for any down payment associated with a loan granted with the aid of the present invention. This feature is particularly useful with loans that are extended within a short time period after the application is initiated.

A further benefit of the present invention is that a detailed and automatically produced set of information is provided to the borrower 101. This information, generated by the central server 103, gives the borrower direct information about the loan that is offered, and reduces the opportunity for a lending agent or other middle man to inflate the interest rate of the loan or to otherwise deceive the borrower.

It is also to be understood that information obtained from the Daily Banking System, the credit bureaus, and from any other source of information used to create the reports contemplated herein may utilize any suitable form of InfoServer, either independently or shared.

It is obvious to those skilled in the relevant arts that the invention described in the above embodiments may be practiced in alternative embodiments which are not explicitly described herein. It is therefore to be noted that the scope of the present invention is to be defined by the appended claims, and not by the examples presented herein.

What is claimed is:

1. A computer implemented method for generation of enhanced data to evaluate a proposed borrower, comprising the steps of:
obtaining from said borrower a first set of information, said first set of information including identification information to identify said borrower to a set of information sources;
communicating a request to one or more recipient financial information sources, wherein each of said recipient information sources is contained within said set of information sources, wherein said recipient information sources comprise one or more credit bureaus and one or more of a plurality of banks, and one or more government entities, and wherein said request includes identification information identifying said borrower to the one or more recipient information sources receiving said request;
wherein at least one of said recipient financial information sources utilizes a communication buffer so that the request is not communicated directly to said at least one recipient financial information source in association with which the communication buffer is utilized;
receiving a second set of information from one or more of said recipient information sources;
automatically generating a consolidated report based upon said second set of information; and
determining whether to loan money to said borrower based upon said consolidated report.

2. The method according to claim 1, wherein said step of determining is performed by one or more lenders and further comprising the steps of communicating said consolidated report to said one or more lenders.

3. The method according to claim 1, wherein said first set of information includes one or more of a social security number, a banking institution identifier, a bank account identifier and a taxpayer number.

4. The method according to claim 1, wherein said first set of information comprises an electronic signature associated with said borrower;

5. The method according to claim 1, wherein said government entity is at least one of a government taxing authority, the Internal Revenue Service and the Social Security Administration.

6. The method according to claim 1, wherein said step of communicating a request comprises electronic communications of said request in a format acceptable to said one or more lenders.

7. The method according to claim 1, wherein said step of communicating a request comprises communication through an intermediate computer in order to provide a secure interface to said one or more recipient financial information sources.

8. The method according to claim 1, wherein said second set of information comprises a bank account balance received from said one or more banks

9. The method according to claim 1, wherein said second set of information comprises annual earning information received from said one or more government entities.

10. The method according to claim 1, wherein said second set of information comprises a deposit history received from said one or more banks.

11. The method according to claim 1, wherein said step of generating comprises assembling said second set of information into an application, wherein said application is formatted according to requirements of a lender.

12. The method according to claim 1, wherein said step of determining further comprises the step of receiving and analyzing an authorization from one or more lenders.

13. The method according to claim 1, wherein said consolidated report comprises a confirmation code.

14. A system for generation of enhanced data to evaluate a proposed borrower, comprising:
means for obtaining from said borrower a first set of information, said first set of information including identification information to identify said borrower to a set of information sources;
means for communicating a request to one or more recipient information sources, wherein each of said recipient information sources is contained within said set of information sources, wherein said recipient information sources comprise one or more credit bureaus and one or more of one or more banks, and one or more government entities, and wherein said request includes identification information identifying said borrower to the one or more recipient information sources receiving said request;
means for receiving a second set of information from one or more of said recipient information sources;
means for generating a consolidated report based upon said second set of information; and
means for determining whether to lend money to said borrower based upon said consolidated report.

15. The system according to claim 14, wherein said means for determining is performed by one or more lenders and further comprises means for communicating said consolidated report to said one or more lenders.

16. The system according to claim 14, wherein said first set of information comprises one or more of a social security number, a banking institution identifier, a bank account identifier and a taxpayer number.

17. The system according to claim 14, wherein said first set of information comprises an electronic signature associated with said borrower;

18. The system according to claim 14, wherein said government entity comprises one or more of a government taxing authority, the Internal Revenue Service and the Social Security Administration.

19. The system according to claim 14, wherein said means for communicating a request comprises means for electronic communications of said request in a format acceptable to said one or more lenders.

20. The system according to claim 14, wherein said means for communicating a request comprises means for communicating through an intermediate computer in order to provide a secure interface to said one or more recipient information sources.

21. The system according to claim 14, wherein said second set of information comprises a bank account balance received from said one or more banks

22. The system according to claim 14, wherein said second set of information comprises annual earnings information received from said one or more government entities.

23. The system according to claim 14, wherein said second set of information comprises a deposit history received from said one or more banks.

24. The system according to claim 14, wherein said means for generating comprises means for assembling said second set of information into an application, wherein said application is formatted according to requirements of a lender.

25. The system according to claim 14, wherein said means for determining further comprises means for receiving and analyzing an authorization from one or more lenders.

26. The method according to claim 14, wherein said consolidated report comprises a confirmation code.

27. An automated credit worthiness determination system, comprising:
an applicant interface for obtaining from a credit applicant a first set of information, said first set of information comprising information to identify said credit applicant to a set of financial information sources;
a central server, wherein said central server
communicates a request to one or more recipient financial information sources, wherein each of said recipient financial information sources is contained within said set of financial information sources, wherein said recipient financial information sources comprises one or more of one or more banks, one or more credit bureaus and one or more government entities and wherein said request contains information identifying said credit applicant to the one or more recipient financial information source receiving said request,
receives a second set of information from one or more of said recipient financial information sources,
generates a consolidated credit report based upon said second set of information; and
determines whether to extend credit to said credit applicant based upon said consolidated credit report.

28. A system according to claim 27, further comprising an intermediate computer, wherein said intermediate computer provides an interface to a computer system associated with one of said recipient financial information sources.
